(19) United States
(12) Patent Application Publication
(10) Pub. No.: US 2016/0271005 A1
(43) Pub. Date: Sep. 22, 2016

(54) A MASSAGING DEVICE

(71) Applicant: Hasmik Morcos, Cronulla, New South Wales (AU)

(72) Inventor: Hasmik Morcos, Cronulla, New South Wales (AU)

(21) Appl. No.: 15/035,323

(22) PCT Filed: Dec. 15, 2014
(86) PCT No.: PCT/AU2014/001122

§ 371 Date: May 9, 2016

(30) Foreign Application Priority Data
Dec. 16, 2013 (AU) 2013904897

(51) Int. Cl. A61H 9/00

(52) U.S. Cl. CPC A61H 9/0078; A61H 2201/165; A61H 2205/06; A61H 2205/10; A61H 2209/00

(57) ABSTRACT

There is disclosed herein a massaging device (10) for a limb having a distal end and a proximal end. The massaging device (10) includes a garment (12) configured to be worn on the limb, the garment including two or more inflatable bladders (24, 26, 28, 30) arrangeable in series between the distal and proximal ends of the limb, with each of the bladders (24, 26, 28, 30) substantially surrounding at least a portion of the limb. The massaging device (10) further includes a pressuriser (38) for supplying pressurised fluid to the bladders (24, 26, 28, 30). The massaging device (10) further includes a controller (40, 42) connected to the pressuriser (38) and configured to sequentially distribute the pressurised fluid to each bladder (24, 26, 28, 30) for inflation from the distal-most bladder to the proximal-most bladder such that a pressure wave moving towards the proximal end is exerted on said portion of the limb.

### FIELD

The present invention relates to a massaging device for a limb.

The present invention has been developed primarily for use in massaging a leg. However, it will be appreciated that the invention is not limited to this particular field of use and is also suitable for massaging an arm.

### BACKGROUND

As blood in the veins of a limb (e.g. leg or arm) generally flows in an upward direction (i.e. against gravity) back to the heart, mechanical forces from the movement of surrounding muscles are required to assist with the blood flow. Similarly, the lymphatic system in the limb also requires movement of surrounding muscles to assist with the movement of the lymphatic fluid towards the torso. However, sitting or standing still for extended periods of time (e.g. during airplane or bus travel) can allow blood and lymphatic fluid to pool in the limb and thus increase the risk of developing health issues such as deep vein/venous thrombosis (DVT) and edema.

In an attempt to prevent the development of DVT and/or edema during extended periods of non-movement, compression hosieries are worn. Compression hosieries are designed to exert a substantially static pressure onto parts or all of the legs such that circulation of blood/lymphatic fluid is promoted.

However, there are questions as to the efficacy of compression hosieries in promoting blood/lymphatic fluid circulation and consequently preventing the development of DVT and/or edema. Moreover, the improper use of these compression hosieries can sometimes lead to other complications such as pressure ulcers, arterial occlusion and gangrene. Further, compression hosieries are often quite difficult to wear, requiring substantial force to pull them into proper position on the leg(s). Still further, compression hosieries often lose their ability to compress after extensive use.

### OBJECT OF INVENTION

It is the object of the present invention to substantially overcome or at least ameliorate one or more of the above disadvantages, or at least provide a useful alternative.

### SUMMARY OF INVENTION

There is disclosed herein a massaging device for a limb having a distal end and a proximal end, the massaging device including:
a garment configured to be worn on the limb, the garment including two or more inflatable bladders arrangeable in series between the distal and proximal ends of the limb, with each of the bladders substantially surrounding at least a portion of the limb;
a pressuriser for supplying pressurised fluid to the bladders; and
a controller connected to the pressuriser and configured to sequentially distribute the pressurised fluid to each bladder for inflation from the distal-most bladder to the proximal-most bladder such that a pressure wave moving towards the proximal end is exerted on said portion of the limb.

The controller preferably is further configured to release the pressurised fluid from each bladder after inflation.

The controller preferably is configured to sequentially and repeatedly distribute the pressurised fluid to each bladder for inflation from the distal-most bladder to the proximal-most bladder such that a pressure wave moving towards the proximal end is repeatedly exerted on said portion of the limb. The controller is further configured to release the pressurised fluid from each bladder after inflation and prior to distributing the pressurised fluid to the bladder next in the sequence.

The controller preferably comprises a timer and a sequential pressure distributor, the timer being configured to measure at least a predetermined amount of time, the sequential pressure distributor being connected to the pressuriser and configured to sequentially connect to each bladder from the distal-most bladder to the proximal-most bladder for the distribution of the pressurised fluid, and wherein the distributor connects to the bladder next in the sequence when the predetermined amount of time is measured by the timer.

The pressuriser preferably comprises an air pump for supplying pressurised air to the bladders.

The bladders preferably are substantially parallel to each other.

Each bladder preferably is substantially adjacent to at least another bladder.

Each bladder preferably is formed from flat rubber or surgical tubing.

Each bladder preferably has a radius of at least 2.54 cm when inflated.

The two or more inflatable bladders preferably are four inflatable bladders.

The two or more inflatable bladders preferably are six inflatable bladders.

The garment preferably includes a first end and a second end with a plurality of hooks and a plurality of corresponding loops respectively thereon, wherein the hooks and loops allow removable attachment of the garment to the limb.

The massaging device preferably further comprises a power supply configured to power the pressuriser and the controller.

The power supply preferably comprises a battery.

The power supply preferably comprises a Universal Serial Bus (USB) connection for receiving power from an external source.

There is also disclosed herein a method of massaging a limb having a distal end and a proximal end, the method comprising:
providing a massaging device including a garment, the garment having two or more inflatable bladders;
wearing the garment on the limb such that the bladders are arranged in series between the distal and proximal ends of the limb, with each of the bladders substantially surrounding at least a portion of the limb; and
sequentially inflating the bladders from the distal-most bladder to the proximal-most bladder such that a pressure wave moving towards the proximal end is exerted on said portion of the limb.

The bladders preferably are sequentially and repeatedly inflated from the distal-most bladder to the proximal-most bladder such that a pressure wave moving towards the proximal end is repeatedly exerted on said portion of the limb.

The method preferably further comprises deflating one of the bladders that has been inflated prior to inflating the bladder next in the sequence.

The method preferably further comprises measuring a predetermined amount of time and inflating the bladder next in sequence upon measurement of the predetermined amount of time.

### BRIEF DESCRIPTION OF DRAWINGS

A preferred embodiment of the invention will be described hereinafter, by way of example only, with reference to the accompanying drawing, wherein:

FIG. 1 is a top view of an embodiment of a massaging device;

FIG. 2 is a schematic view of the massaging device of FIG. 1;

FIG. 3 is a perspective view of another embodiment of a massaging device;

FIG. 4 is a perspective view of a case of the massaging device of FIG. 3 detached from a garment of the massaging device of FIG. 3; and

FIG. 5 is a top view of the case of FIG. 4.

### DESCRIPTION OF EMBODIMENTS

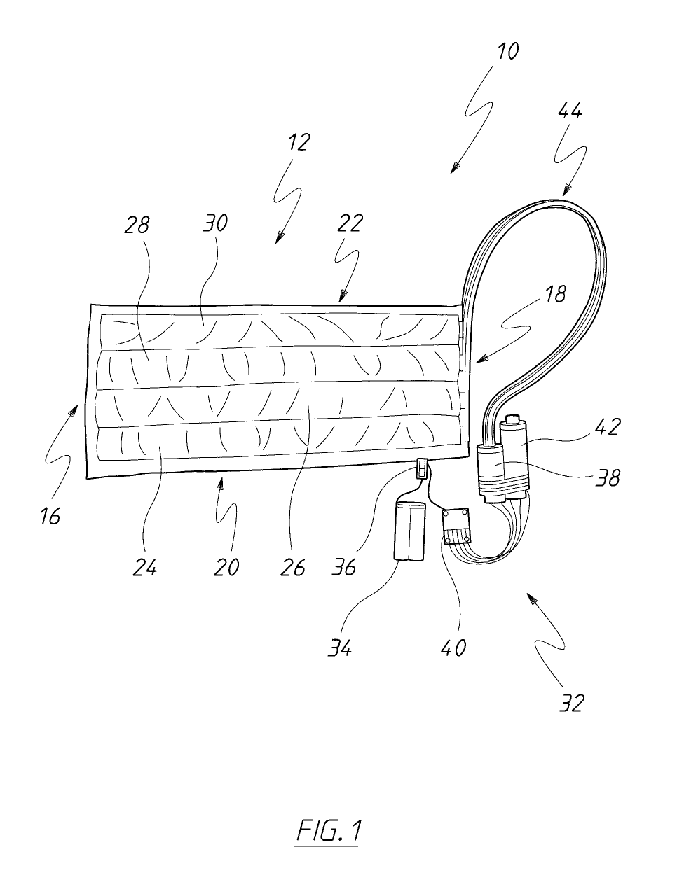

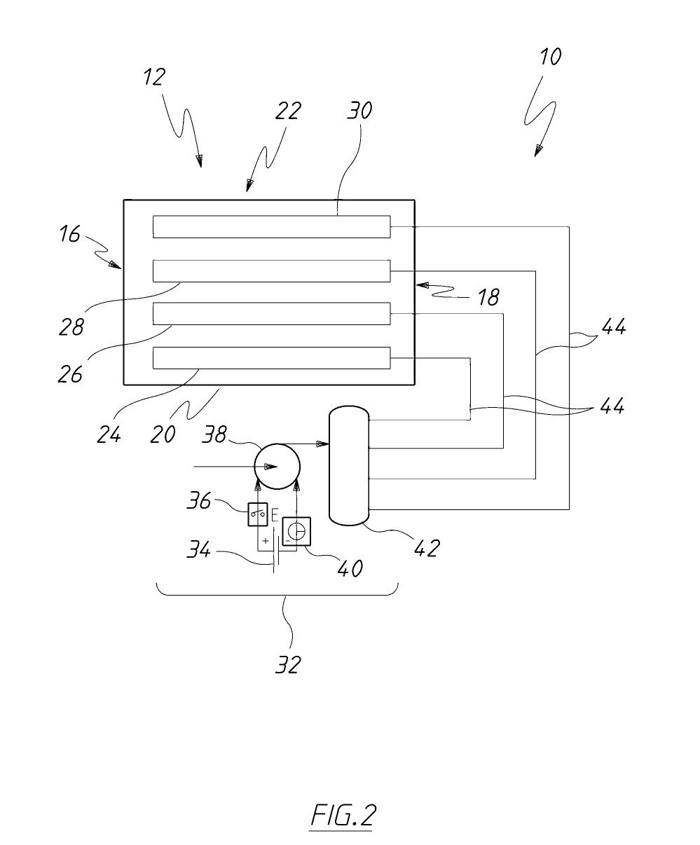

FIGS. 1 and 2 show an embodiment of a massaging device 10 for a leg of a person. The massaging device 10 includes a flexible fabric garment 12 configured to be worn around the calf of the leg. The garment 12 is substantially rectangular in shape and is defined by two ends 16, 18 and two longitudinal sides 20, 22. A plurality of hooks (not shown) are located on the end 16 and a plurality of corresponding loops (not shown) are located on the end 18. The hooks and loops are configured to removable engage each other such that the garment 12 is able to substantially wrap around the calf for removable attachment and securing thereto.

The garment 12 includes four inflatable elongate bladders 24, 26, 28, 30 that are positioned in series between the sides 20, 22 and substantially parallel to each other. Each of the bladders 24, 26, 28, 30 extends between the sides 20, 22 and is substantially adjacent to at least another bladder 24, 26, 28, 30. Each of the bladders 24, 26, 28, 30 is configured to inflate when pressurised air is received therein. Each of the bladders 24, 26, 28, 30 is formed from flat rubber such that they are substantially flat when deflated and have a radius of at least 2.54 cm when inflated.

The massaging device 10 further includes an electrical system 32, a battery 34 for powering the electrical system 32, and an “On/Off” switch 36 to control whether the battery 34 powers the electrical system 32. The electrical system 32 comprises a pressuriser and a controller. The pressuriser is in the form of an electronically powered air pump 38 for supplying pressurised air. The controller is in the form an electronic timer 40 and a sequential pressure distributor 42. The distributor 42 is an electromechanical valve mechanism connected to the air pump 38 and configured to sequentially and repeatedly connect the air pump 38 to each of the bladders 24, 26, 28, 30 via tubing 44 in the following order:
1. bladder 24;
2. bladder 26;
3. bladder 28; and then
4. bladder 30.

The timer 40 is configured to repeatedly measure a predetermined amount of time varying between 10 to 45 seconds and send a signal to the distributor 38 each instance the predetermined amount of time is measured. The distributor 42 is configured to connect the air pump 38 to the bladder 24, 26, 28, 30 next in the sequence when the signal is received from the timer 40. During the connection between the air pump 38 and the bladder 24, 26, 28, 30 next in the sequence, the distributor 42 is further configured to connect the previously connected bladder 24, 26, 28, 30 to the outside environment.

A typical use and operation of the massaging device 10 will now be described.

The garment 12 is wrapped around the calf of the leg such that the bladders 24, 26, 28, 30 are arranged in series between the distal and proximal ends of the leg, the bladder 24 being the distal-most bladder and the bladder 30 being the proximal-most bladder. Each of the bladders 24, 26, 28, 30 substantially surrounds a respective portion of the calf. The hooks and loops are then engaged with each other such that the garment 12 is removably attached and secured to the calf. Then the switch 36 is switched on such that the battery 34 powers the electrical system 32.

Upon the electrical system 32 being powered, the distributor 42 connects the air pump 38 to the bladder 24 such that pressurised air is supplied to the bladder 24 for inflation. The inflation of the bladder 24 causes a pressure to be exerted onto the portion of the calf surrounded by the bladder 24.

When the timer 40 measures the predetermined amount of time, a signal is sent to the distributor 42. Upon receiving the signal, the distributor 42 starts to connect the air pump 38 to the bladder 26. During this connection, the distributor 42 connects the bladder 24 to the outside environment such that the pressurised fluid in the bladder 24 is released for deflation. The deflation of the bladder 24 removes the pressure exerted onto the portion of the calf surrounded by the bladder 24. When the connection between the air pump 38 and the bladder 26 is made, pressurised air is supplied to the bladder 26 for inflation. The inflation of the bladder 26 causes a pressure to be exerted onto the portion of the calf surrounded by the bladder 26.

When the timer 40 again measures the predetermined amount of time, a signal is sent to the distributor 42. Upon receiving the signal, the distributor 42 starts to connect the air pump 38 to the bladder 28. During this connection, the distributor 42 connects the bladder 26 to the outside environment such that the pressurised fluid in the bladder 26 is released for deflation. The deflation of the bladder 26 removes the pressure exerted onto the portion of the calf surrounded by the bladder 26. When the connection between the air pump 38 and the bladder 28 is made, pressurised air is supplied to the bladder 28 for inflation. The inflation of the bladder 28 causes a pressure to be exerted onto the portion of the calf surrounded by the bladder 28.

When the timer 40 again measures the predetermined amount of time, a signal is sent to the distributor 42. Upon receiving the signal, the distributor 42 starts to connect the air pump 38 to the bladder 30. During this connection, the distributor 42 connects the bladder 28 to the outside environment such that the pressurised fluid in the bladder 28 is released for deflation. The deflation of the bladder 28 removes the pressure exerted onto the portion of the calf surrounded by the bladder 28. When the connection between the air pump 38 and the bladder 30 is made, pressurised air is supplied to the bladder 30 for inflation. The inflation of the bladder 30 causes a pressure to be exerted onto the portion of the calf surrounded by the bladder 30.

When the timer 40 again measures the predetermined amount of time, a signal is sent to the distributor 42. Upon receiving the signal, the distributor 42 starts to connect the air pump 38 to the bladder 24. During this connection, the distributor 42 connects the bladder 30 to the outside environment such that the pressurised fluid in the bladder 30 is released for deflation. The deflation of the bladder 30 removes the pressure exerted onto the portion of the calf surrounded by the bladder 30. When the connection between the air pump 38 and the bladder 24 is made, pressurised air is supplied to the bladder 24 for inflation. The inflation of the bladder 24 causes a pressure to be exerted onto the portion of the calf surrounded by the bladder 24.

The above sequence of inflation and deflation of the bladders 24, 26, 28, 30 will continuously be repeated until the switch 36 is switched off such that the electrical system 32 is no longer powered. During the above sequence, it will be appreciated that the pressures exerted onto the portions of the calf will simulate a pressure wave moving towards the proximal end of the leg that is repeatedly exerted onto the calf. It will also be appreciated that the controller is configured to re-start the above sequence of inflation and deflation of the bladders 24, 26, 28, 30 from the bladder 24 (i.e. the distal-most bladder) whenever the electrical system 32 is powered off and then powered on again.

An advantage of the massaging device 10 is that the repeating pressure wave promotes blood/lymphatic fluid circulation in the leg by assisting the blood/lymphatic fluid towards the proximal end of the leg (i.e. towards the heart and torso). This is particularly beneficial when attempting to reduce the risk of developing DVT or edema. The massaging device 10 provides and/or enhances a peristaltic action axially along the leg or arm towards the heart and torso.

Another advantage of the massaging device 10 is that it does not apply a constant pressure to the legs. Accordingly, there is a reduced risk of causing other heath complications.

Other advantages of the massaging device 10 are that it is easy to wear and remove, and that it is portable to carry.

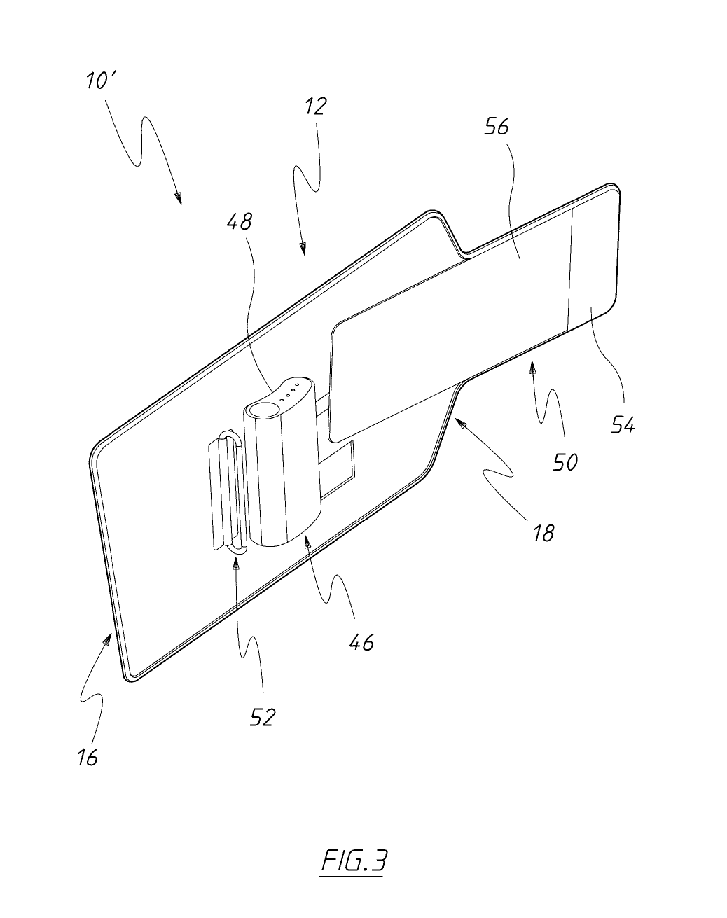

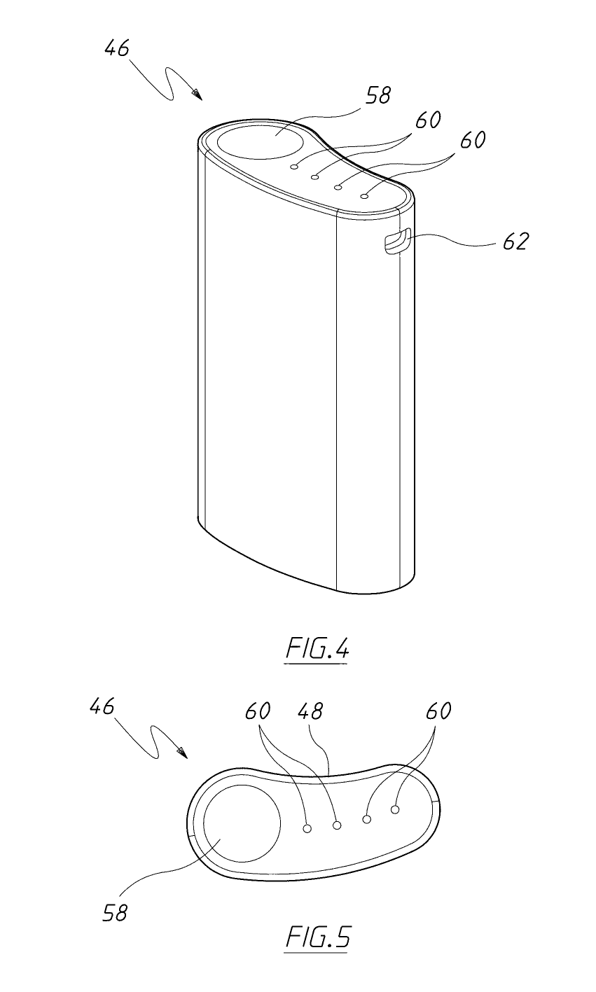

FIGS. 3 to 5 show another embodiment of a massaging device 10′ in which like reference numerals are used to denote like features to that of the massaging device 10. In this embodiment, the massaging device 10′ further includes a rigid case 46 configured to house the electrical system 32 and the battery 34 therein. The case 46 has an outer surface 48 which is concaved such that, in use, it can be placed ergonomically against the calf of the leg. As seen in FIGS. 4 and 5, the case 46 is detachable from the garment 12.

In this embodiment, the garment 12 has a strap 50 and a strap loop 52. The strap 50 extends from the end 18 and the strap loop 52 is located between the end 16 and the case 46. The plurality of hooks 54 are located on an outer surface of the garment 12 located at the free end of the strap 50. The plurality of corresponding loops 56 are located on an outer surface of the garment 12 between the plurality of hooks 54 and the case 46. It will be appreciated, as the garment 12 is wrapped around the calf of the leg, the strap 50 is pivotally threaded through the strap loop 52 such that the hooks 54 and loops 56 are able to removably engage.

In this embodiment, the garment 12 includes six inflatable elongate bladders (not shown) that are substantially the same as those of bladders 24, 26, 28, 30 and operate in much the same manner.

In this embodiment, the case 46 has an actuatable button 58 which acts as the “On/Off” switch. Also, the button 58 is configured to allow the user to select how long the massaging device 10′ will operate by cycling through predetermined time settings (e.g. 5, 10, and 15 minutes). For example, a first actuation of the button 58 will turn on the massaging device 10′ for 5 minutes, a second actuation of the button 58 will turn on the massaging device 10′ for 10 minutes, a third actuation of the button 58 will turn on the massaging device 10′ for 15 minutes, and a fourth actuation of the button 58 will turn off the massaging device 10′. The electrical system 32 further comprises a series of LED lights 60 viewable through the top of the case 46. The LED lights 60 provide indications of what predetermined time setting has been selected.

In this embodiment, the electrical system 32 further comprises a micro-USB port 62 which is accessible through the side of the case 46. The port 62 allows power to be received from an external source (e.g. a computer) to recharge the battery 34. It will also be appreciated that, in other embodiments, the massaging device 10′ does not have the battery 34 and instead the port 62 allows power from the external source to directly power the electrical system 32.

Although the invention has been described with reference to a preferred embodiment, it will be appreciated by a person skilled in the art that the invention may be embodied in many other forms. For example, in another embodiment, the massaging device 10 may be for an arm of a person.

1. A massaging device for a limb having a distal end and a proximal end, the massaging device including:
a garment configured to be worn on the limb, the garment including two or more inflatable bladders arrangeable in series between the distal and proximal ends of the limb, with each of the bladders substantially surrounding at least a portion of the limb;
a pressuriser for supplying pressurised fluid to the bladders; and
a controller connected to the pressuriser and configured to sequentially distribute the pressurised fluid to each bladder for inflation from the distal-most bladder to the proximal-most bladder such that a pressure wave moving towards the proximal end is exerted on said portion of the limb.

2. The device according to claim 1, wherein the controller is further configured to release the pressurised fluid from each bladder after inflation.

3. The device according to claim 1, wherein the controller is configured to sequentially and repeatedly distribute the pressurised fluid to each bladder for inflation from the distal-most bladder to the proximal-most bladder such that a pressure wave moving towards the proximal end is repeatedly exerted on said portion of the limb.

4. The device according to claim 3, wherein the controller is further configured to release the pressurised fluid from each bladder after inflation and prior to distributing the pressurised fluid to the bladder next in the sequence.

5. The device according to claim 3 or 4, wherein the controller comprises a timer and a sequential pressure distributor, the timer being configured to measure at least a predetermined amount of time, the sequential pressure distributor being connected to the pressuriser and configured to sequentially connect to each bladder from the distal-most bladder to the proximal-most bladder for the distribution of the pressurised fluid, and wherein the distributor connects to the bladder next in the sequence when the predetermined amount of time is measured by the timer.

6. The device according to any one of the preceding claims, wherein the pressuriser comprises an air pump for supplying pressurised air to the bladders.

7. The device according to any one of the preceding claims, wherein the bladders are substantially parallel to each other.

8. The device according to any one of the preceding claims, wherein each bladder is substantially adjacent to at least another bladder.

9. The device according to any one of the preceding claims, wherein each bladder is formed from flat rubber or surgical tubing.

10. The device according to any one of the preceding claims, wherein each bladder has a radius of at least 2.54 cm when inflated.

11. The device according to any one of the preceding claims, wherein the two or more inflatable bladders are four inflatable bladders.

12. The device according to any one of claims 1 to 10, wherein the two or more inflatable bladders are six inflatable bladders.

13. The device according to any one of the preceding claims, wherein the garment includes a first end and a second end with a plurality of hooks and a plurality of corresponding loops respectively thereon, wherein the hooks and loops allow removable attachment of the garment to the limb.

14. The device according to any one of the preceding claims, further comprising a power supply configured to power the pressuriser and the controller.

15. The device according to claim 14, wherein the power supply comprises a battery.

16. The device according to claim 14, wherein the power supply comprises a Universal Serial Bus (USB) connection for receiving power from an external source.

17. A method of massaging a limb having a distal end and a proximal end, the method comprising:
providing a massaging device including a garment, the garment having two or more inflatable bladders;
wearing the garment on the limb such that the bladders are arranged in series between the distal and proximal ends of the limb, with each of the bladders substantially surrounding at least a portion of the limb; and
sequentially inflating the bladders from the distal-most bladder to the proximal-most bladder such that a pressure wave moving towards the proximal end is exerted on said portion of the limb.

18. The method according to claim 17, wherein the bladders are sequentially and repeatedly inflated from the distal-most bladder to the proximal-most bladder such that a pressure wave moving towards the proximal end is repeatedly exerted on said portion of the limb.

19. The method according to claim 17 or 18, further comprising deflating one of the bladders that has been inflated prior to inflating the bladder next in the sequence.

20. The method according to any one of claim 17 to 19, further comprising measuring a predetermined amount of time and inflating the bladder next in sequence upon measurement of the predetermined amount of time.
